(19) United States
(12) Patent Application Publication
(10) Pub. No.: US 2026/0062522 A1
(43) Pub. Date: Mar. 5, 2026

(54) IONOMER DISPERSANT FOR MAKING AQUEOUS POLYOLEFIN DISPERSIONS

(71) Applicant: Dow Global Technologies LLC, Midland, MI (US)

(72) Inventors: Hari Katepalli, Midland, MI (US); David L. Malotky, Midland, MI (US); Alexander Williamson, Rosharon, TX (US); Joshua Enokida, Houston, TX (US); Leslie O'Leary, Sugar Land, TX (US)

(73) Assignee: Dow Global Technologies LLC, Midland, MI (US)

(21) Appl. No.: 19/105,247

(22) PCT Filed: Aug. 22, 2023
(86) PCT No.: PCT/US2023/072647

§ 371 Date: Feb. 20, 2025

Related U.S. Application Data
(60) Provisional application No. 63/399,869, filed on Aug. 22, 2022.

(51) Int. Cl. C08J 3/05; C08J 3/20; C08K 3/22; C08K 3/26

(52) U.S. Cl. CPC C08J 3/05; C08J 3/203; C08K 3/22; C08J 2323/12; C08J 2423/08; C08K 2003/262

(57) ABSTRACT

Methods for producing an aqueous polyolefin dispersion comprise providing a partially neutralized ionomer dispersant, which is an ethylene acid copolymer comprising the polymerized reaction product of 70 to 85 wt. % ethylene and 15 to 30 wt. % carboxylic acid containing comonomer, based on the total weight of monomers present in the ethylene acid copolymer, of which 0.01 to 30 mole % of the acid units are neutralized by alkali metal cations based on the total weight of monomers present in the ethylene acid copolymer. The methods further comprise melt blending the partially neutralized ionomer dispersant and polyolefin to produce a polymer melt blend, emulsifying the polymer melt blend in the presence of water and additional base to produce an emulsion, wherein the additional base further neutralizes a fraction or all of the remaining acid units, and diluting the emulsion with additional water to produce the aqueous polyolefin dispersion.

### CROSS REFERENCE TO RELATED APPLICATIONS

This application claims benefit of priority under 35 U.S.C. § 119 to U.S. Application No. 63/399,869, filed Aug. 22, 2022, which is hereby incorporated by reference herein in its entirety.

### FIELD

Embodiments disclosed herein generally relate to methods for making aqueous polyolefin dispersions and more specifically, to aqueous polyolefin dispersions that include an ionomer dispersant.

### TECHNICAL BACKGROUND

Ethylene acrylic acid (EAA) and ethylene methacrylic acid (EMAA) copolymers are commonly used as dispersants in making dispersions of various polyolefin polymers. When used in such dispersions, EAA/EMAA copolymers often do not achieve stable dispersions of polyolefin resins, especially when the AA or MAA content is low or the molecular weight is high in the dispersant resin.

Accordingly, there is a continual need for improved EAA or EMAA dispersants to make processable and stable aqueous dispersions of polyolefins.

### SUMMARY

Embodiments of the present disclosure meet this need for improved aqueous polyolefin dispersions by blending the base polyolefin with an EAA or EMAA copolymer that is partially neutralized with an alkali metal cation (e.g., sodium) to form a partially neutralized ionomer, and then further neutralizing the partially neutralized ionomer with a base during emulsification. Without being limited by theory, these ionomers partially neutralized by alkali metal cations (e.g., sodium) provide a good balance of viscosity and hydrophilicity, which aids in the processability and stability of the aqueous polyolefin dispersion.

According to one or more embodiments of the present disclosure, a method of producing an aqueous polyolefin dispersion is provided. The method comprises providing a partially neutralized ionomer dispersant, which comprises an ethylene acid copolymer comprising the polymerized reaction product of 70 to 85 wt. % ethylene and 15 to 30 wt. % carboxylic acid containing comonomer units, based on the total weight of monomers present in the ethylene acid copolymer, of which 0.01 to 30 mole % of the acid units are neutralized by alkali metal cations. The method further comprises melt blending the partially neutralized ionomer dispersant and one or more polyolefins to produce a polymer melt blend; emulsifying the polymer melt blend in the presence of water and additional base to produce an emulsion, wherein the additional base further neutralizes a fraction or all of the remaining acid units of the partially neutralized ionomer; and diluting the emulsion with additional water to produce the aqueous polyolefin dispersion.

It is to be understood that both the preceding general description and the following detailed description describe various embodiments and are intended to provide an overview or framework for understanding the nature and character of the claimed subject matter. Additional features and advantages of the embodiments will be set forth in the detailed description, and, in part, will be readily apparent to persons of ordinary skill in the art from that description, which includes the accompanying drawings and claims, or recognized by practicing the described embodiments. The drawings are included to provide a further understanding of the embodiments, and together with the detailed description, serve to explain the principles and operations of the claimed subject matter. However, the embodiments are illustrative and exemplary in nature, and not intended to limit the claimed subject matter.

### BRIEF SUMMARY OF FIGURES

FIG. 1 is a graph illustrating the calculation of the processability factor for Inventive Example 2; and

FIG. 2 is a graph illustrating the calculation of the processability factor for Inventive Example 6.

### DETAILED DESCRIPTION

Specific embodiments of the present application will now be described. These embodiments are provided so that this disclosure will be thorough and complete and will fully convey the scope of the subject matter to those skilled in the art.

The term “polymer” refers to a polymeric compound prepared by polymerizing monomers, whether of a same or a different type. The generic term polymer thus embraces the term “homopolymer,” which usually refers to a polymer prepared from only one type of monomer as well as “copolymer,” which refers to a polymer prepared from two or more different monomers. The term “interpolymer,” as used herein, refers to a polymer prepared by the polymerization of at least two different types of monomers. The generic term interpolymer thus includes a copolymer or polymer prepared from more than two different types of monomers, such as terpolymers.

“Polyethylene” or “ethylene-based polymer” shall mean polymers comprising greater than 50% by mole of units derived from ethylene monomer. This includes ethylene-based homopolymers or copolymers (meaning units derived from two or more comonomers). Common forms of ethylene-based polymers known in the art include, but are not limited to, Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE).

“Polypropylene” or “propylene based polymer” shall mean polymers comprising greater than 50% by mole of units derived from propylene monomer. This includes propylene-based homopolymers or copolymers (meaning units derived from two or more comonomers). Common forms of propylene-based polymers known in the art include, but are not limited to, impact polypropylene copolymers (icPP), random copolymers (rcPP), polypropylene homopolymers (hPP), propylene/ethylene copolymers (POE plastomers), and polypropylene reactor blends.

“Ethylene acid copolymer” is a polymerized reaction product of ethylene and one or more unsaturated carboxylic acids.

As used herein, “dispersion” and related terms refer to solid particles, such as, polymer particles suspended within an aqueous liquid phase. Further as used herein, “dispersant” refers to a composition directed to maintaining the suspension of the polymer particles within the aqueous liquid phase.

Embodiments of the present disclosure are directed to systems and methods for producing an aqueous polyolefin dispersion by utilizing a partially neutralized ionomer dispersant, which comprises ethylene acid copolymer. Ethylene acid copolymers comprise the polymerized reaction product of 70 to 85 wt. % ethylene and 15 to 30 wt. % carboxylic acid containing comonomer, based on the total weight of monomers present in the ethylene acid copolymer, of which 0.01 to 30 mole % of the acid units are neutralized by alkali metal cations. The partially neutralized ionomer dispersant and one or more polyolefins are melt blended to produce a polymer melt blend and then the polymer melt blend is emulsified in the presence of water and additional base to produce an emulsion, wherein the additional base further neutralizes acid units of the partially neutralized ionomer. Then, the emulsion is diluted with additional water to produce the aqueous polyolefin dispersion.

### Aqueous Polyolefin Dispersion

In embodiments herein, the aqueous polyolefin dispersion may comprise smaller particle size and better dispersion quality. All individual values and subranges are included and disclosed herein. As used herein, the total resin solids content is comprised of the ionomer, polyolefin, and potentially some alkali metal cation-containing base. Without being bound by theory, the present systems and methods, specifically, the alkali metal partially neutralized ionomer added to the polymer blend may ensure a balance of melt viscosity within the base resin or may ensure more efficient neutralization, as some neutralization may have already occurred, thereby resulting in smaller particle size and better dispersion quality. Within the total resin solids content, there may be 5 to 50 wt. % of ionomer and 50 to 95 wt. % of polyolefin.

The particles present in the aqueous polyolefin dispersion may have a mean particle size of less than or equal to 2.00 μm, or less than 1.50 μm. All individual values and subranges are included and disclosed herein. For examples, the aqueous polyolefin dispersion may have a mean particle size from 0.1 to 1.50 μm, from 0.50 to 1.50 μm, from 0.75 to 1.50 μm, from 0.80 to from 1.40 μm, or from 0.80 to from 1.30 μm. Without being limited by theory, the particles tend not to maintain colloidal stability i.e., remain suspended in the aqueous phase at particle sizes greater than 2.0 μm, and furthermore colloidal stability tends to improve at mean particle sizes less than or equal 1.50 μm.

### Ionomer Dispersant

The ionomer is an ethylene acid copolymer that is partially neutralized by alkali metal cations. The ethylene acid copolymer is the polymerized reaction product of 70 to 85 wt. % ethylene and 15 to 30 wt. % carboxylic acid containing comonomer, based on the total weight of monomers present in the ethylene acid copolymer. All individual values and ranges are included and disclosed herein. For example, in some embodiments, the ethylene acid copolymer is the polymerized reaction product of from 72 to 85 wt. % of ethylene; and from 15 to 28 wt. % carboxylic acid containing comonomer, based on the total weight of monomers present in the ethylene acid copolymer. In other embodiments, the ethylene acid copolymer is the polymerized reaction product of from 75 to 85 wt. % of ethylene; and from 15 to 25 wt. % of a carboxylic acid containing comonomer, based on the total weight of monomers present in the ethylene acid copolymer. In further embodiments, the ethylene acid copolymer is the polymerized reaction product of from 79 to 82 wt. % of ethylene; and from 18 to 21 wt. % of a carboxylic acid containing comonomer, based on the total weight of monomers present in the ethylene acid copolymer. The ethylene acid copolymer may be polymerized according to processes disclosed in U.S. Pat. Nos. 3,404,134; 5,028,674; 6,500,888; and 6,518,365. In some embodiments, blends of two or more ethylene acid copolymers may be used, provided that the aggregate components and properties of the blend fall within the limits described above for the ethylene acid copolymers.

Various carboxylic acid containing comonomers may be utilized in the ethylene acid copolymers. For example, the carboxylic acid containing comonomer may comprise a monocarboxylic acid, which may include acrylic acid, methacrylic acid, or both.

As noted above, the ethylene acid copolymer is already partially neutralized by an alkali metal cation (to form an ionomer) at the point when incorporated into the polymer melt blend to make the dispersion. Referring to the total acid units neutralized, the calculation of percent neutralization is based on the number of acid units considered to be present, based on the known amount of moles of the carboxylic acid containing comonomer and the number of mole equivalents of alkali metal added. In embodiments herein, from 0.01 mole % to 30 mole % of total acid units of the ethylene acid copolymer neutralized by an alkali metal cation. All individual values and subranges are included and disclosed herein. In further embodiments, from 0.1 mole % to 30 mole %, from 1 mole % to 30 mole %, from 2 mole % to 30 mole %, from 2 to 20 mole %, or from 5 to 20 mole % of total acid units may be neutralized in the partial ionomer neutralization step. Without being bound by theory, partially neutralizing to mole % amounts greater than 30% may undesirably increase the melt viscosity in the melt blend, thereby decreasing the processability. In some embodiments, maintaining at neutralization levels of 20% or less may be utilized to ensure processability.

Exemplary alkali metal cations for the partial neutralization include but are not limited to sodium, potassium, and lithium, or combinations thereof. In some embodiments herein, the alkali metal cations are selected from the group comprising sodium, potassium, and lithium, or combinations thereof. In a specific embodiment, the alkali metal cation is sodium.

Prior to partial neutralization, the melt index (I₂) of the ethylene acid copolymer ranges from 75 to 1000 g/10 min as determined according to ASTM D1238 (at 190° C., 2.16 kg). In other embodiments, the melt index of the ethylene acid copolymer ranges may be from 150 to 900 g/10 min, from 175 to 600 g/10 min, from 200 to 400 g/10 min, or from 275 to 325 g/10 min. All individual values and subranges are contained herein.

After partial neutralization, the partially neutralized ionomer may have a melt index (I₂) from 35 to 750 g/10 min. All individual values and subranges are included and disclosed herein. For example, in some embodiments, the ionomer may have a melt index (I₂) from 40 to 250 g/10 min, from 40 to 100 g/10 min, from 60 to 250 g/10 min, or from 60 to 100 g/10 min.

### Polyolefin

As described above, the aqueous polyolefin dispersion described herein comprises a polyolefin. The polyolefin may be selected from the group consisting of polyethylene or polypropylene or copolymers thereof. In one embodiment, the polyolefin comprises polypropylene. In another embodiment, the polyolefin comprises propylene/ethylene copolymer. Other comonomers may include butene, hexene, or octene.

Various densities are considered suitable for the polyolefin. In some embodiments described herein, the polyolefin may have a density of 0.850 g/cc to 0.975 g/cc. All individual values and subranges of at least 0.850 g/cc to 0.975 g/cc are included and disclosed herein. For example, in some embodiments, the polyolefin may have a density of 0.855 to 0.905 g/cc, 0.855 to 0.900 g/cc, 0.855 to 0.900 g/cc, or 0.865 to 0.895 g/cc. Density may be measured in accordance with ASTM D792.

In one or more polypropylene embodiments as measured according to ASTM D-1238, Procedure B (condition 230° C./2.16 kg), the melt flow rate may be less than 30 g/10 min, less than 10 g/10 min, or less than 6 g/10 min. In further embodiments, the polypropylene may have a melt flow rate of 0.5 to 75 g/10 min, 1.0 to 50 g/10 min, 2.0 to 25.0 g/10 min, 5.0 to 15.0 g/10 min, or from 7 to 10.0 g/10 min. In one or more polyethylene embodiments as measured in accordance with ASTM D-1238, Procedure B (condition 190° C./2.16 kg), the polyethylene may have a melt index (I₂) of 0.1 to 100 g/10 mins, 0.5 to 75 g/10 min, 1.0 to 50 g/10 min, 2.0 to 25.0 g/10 min, 2.5 to 10.0 g/10 min, or from 2.5 to 7.5 g/10 min. All individual values and subranges are disclosed herein.

### Additional Additives

The aqueous polyolefin dispersion may contain other optional additives known in the art. Exemplary additives may include, but are not limited to, antioxidants, processing aids, flow enhancing additives, lubricants, pigments, dyes, flame retardants, impact modifiers, nucleating agents, anti-blocking agents such as silica, thermal stabilizers, UV absorbers, UV stabilizers, surfactants, chelating agents, and coupling agents. Additives can be used in the amount ranging from 0.0001 to 5 wt. % based on the weight of the total resin solids content in the aqueous polyolefin dispersion.

### Methods

As previously noted above, the partially neutralized ionomer dispersant and one or more polyolefins are melt blended to produce a polymer melt blend and then the polymer melt blend is emulsified in the presence of water and additional base to produce an emulsion. During the emulsification, the additional base further neutralizes acid units of the partially neutralized ionomer. Various bases are considered suitable for the neutralization step. In one embodiment, the base is an inorganic base such as potassium hydroxide, or sodium hydroxide. Additionally, organic bases such as amines, and ammonia are also suitable. In embodiments, the additional base may comprise multiple bases or a single base. Mixing of the polymer melt blend with the water and base may take place at a temperature of from 100° C. to 250° C. A further optional step after dilution may include cooling the heated aqueous polyolefin dispersion to a temperature of 20-30° C., wherein the ionomer remains dispersed in the liquid phase. Then, the emulsion is diluted with additional water to produce the aqueous polyolefin dispersion.

### Uses

The aqueous polyolefin dispersions described herein may be used to coat a substrate, such as, flooring, plastic parts, wood, textiles, metal, ceramic, fibers, glass, or paper. Suitable substrates may include paperboard, cardboard, pulp-molded shape, woven fabric, nonwoven fabric, film, open-cell foam, closed-cell foam, or metallic foil. In some embodiments herein, a method for coating a substrate comprises: providing an aqueous polyolefin dispersion as described in embodiments herein, applying the aqueous polyolefin dispersion to the substrate to form a coated substrate. Applying may be performed by a dipping method, a spray method, a roll coating method, a doctor blade method, a flow coating method, or other suitable methods for applying liquid coatings that are known in the art. The method may further comprise a drying step.

In other embodiments herein, a method of forming a coated article comprises coating the aqueous polyolefin dispersion as described in one or more embodiments herein onto a substrate to form a coated substrate; and drying the coated substrate to form a coated article.

The aqueous polyolefin dispersion may be utilized in various applications, for example, in water barrier applications, gas barrier applications, oil and grease barrier coatings, heat seal coatings, artificial turf, etc.

### Test Methods

### Density

Density was measured in accordance with ASTM D-792 and reported in grams per cubic centimeter (g/cc).

### Melt Index (I₂)

For ethylene-based polymers, melt index (I₂) was measured in accordance with ASTM D-1238, Procedure B (condition 190° C./2.16 kg) and reported in grams eluted per 10 minutes (g/10 min).

### Melt Flow Rate

For propylene-based polymers, melt flow rate was measured in accordance with ASTM D-1238, Procedure B (condition 230° C./2.16 kg) and reported in grams eluted per 10 minutes (g/10 min).

### Mean Particle Size

Mean particle size is defined as the volume average particle diameter and was measured with a Beckman Coulter LS 13-320 Laser Light Scattering Particle Sizer (Beckman Coulter Inc., Fullerton, California) implementing an epoxy particle model (real fluid refractive index=1.332, real sample refractive index=1.5, imaginary sample refractive index=0). The samples were diluted into an aqueous KOH solution with pH >10 before measuring.

### Dynamic Viscosity

Dynamic viscosity was measured via a Brookfield DV-II+ viscometer equipped with an RV3 spindle. Approximately 0.5 mL of dispersion is loaded into the device and is measured at an appropriate rpm to obtain a steady viscosity value for 15 seconds before recording the dynamic viscosity.

### Processability Factor

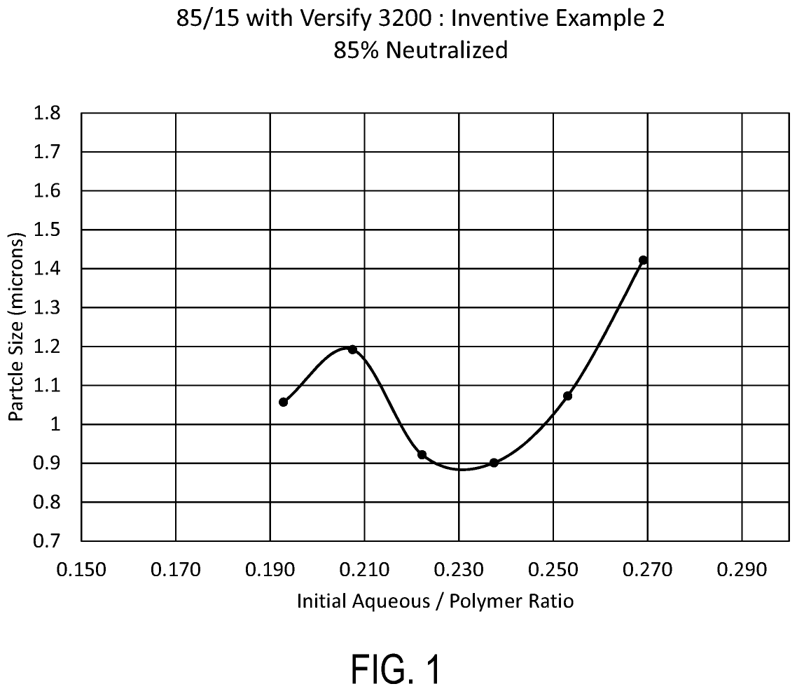

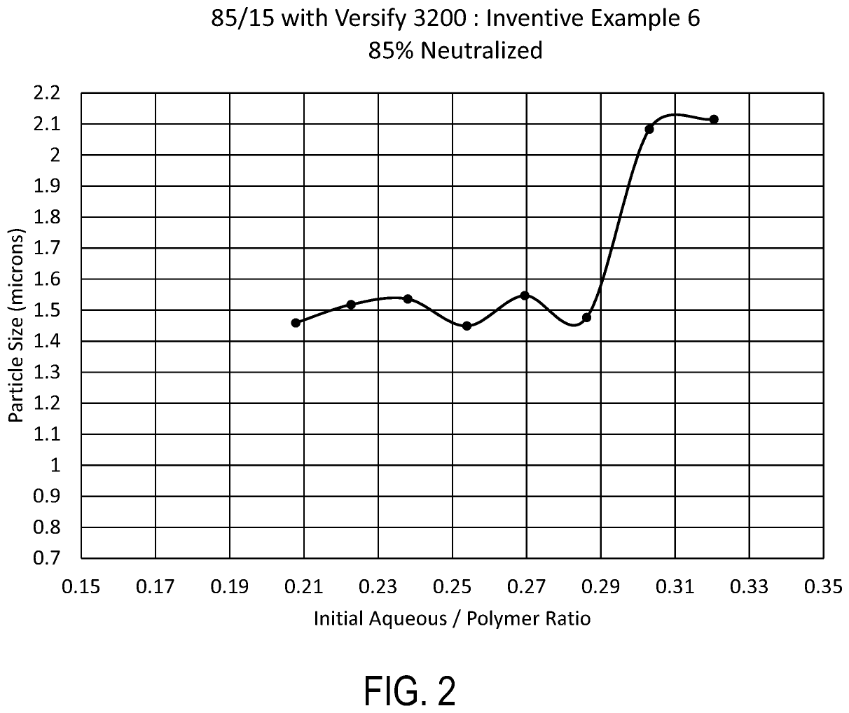

The Processability Factor is defined by plotting a curve of particle size (y-axis) versus initial aqueous/polymer ratio (x-axis), for 15% dispersant, and then by calculating the width of the curve at particle size <1.75 microns. It is calculated by subtracting the lowest measured value on the x-axis of the graph where the particle size on the y-axis on the graph is less than 1.75 microns from the highest measured value on the x-axis of the graph where the particle size on the y-axis on the graph is less than 1.75 microns. To illustrate how the calculation is performed, FIGS. 1 and 2, which are graphical plots of particle size versus initial aqueous/polymer ratio for Inventive Examples 2 and 6 respectively, are provided. The data for FIGS. 1 and 2 are shown below in the following Tables 1 and 2, respectively.

TABLE 1
Data for FIG. 1, Inventive Example 2

| | Particle |
|---|---|
| Initial Aqueous/Polymer | Size |
| ratio | microns |
| 0.193 | 1.057 |
| 0.207 | 1.192 |
| 0.222 | 0.922 |
| 0.237 | 0.901 |
| 0.253 | 1.073 |
| 0.269 | 1.422 |

TABLE 2
Data for FIG. 1, Inventive Example 6

| Initial Aqueous/Polymer | Particle |
|---|---|
| ratio | Size |
| 0.208 | 1.459 |
| 0.223 | 1.518 |
| 0.238 | 1.536 |
| 0.254 | 1.449 |
| 0.269 | 1.547 |
| 0.286 | 1.476 |
| 0.303 | 2.083 |
| 0.320 | 2.115 |

### EXAMPLES

The dispersants were prepared by two methods:

Ionomers 2 to 9 were prepared by first making the ethylene acid copolymers by peroxide initiated free radical polymerization as described below, followed by conversion to ionomers via compounding with sodium carbonate (Na₂CO₃) in an extruder. The extrusion process was performed in two extrusion steps using a 26 mm twin screw extruder with a feed rate of 15 lbs/h and a screw speed of 400 RPM. The barrel temperature was set to 230° C., and vacuum of 20 inHg was pulled through a vent port located after the mixing section. In the first extrusion step, a concentrate resin with a melt index (190° C., 2.16 kg) of approximately 10 g/10 min was produced by separately feeding the ethylene acid copolymer and sodium carbonate into the extruder hopper at desired ratios using gravimetric feeders. In the second extrusion step, the final ionomers with the weighted average level of neutralization shown in Table 3 were produced by dry blending the concentrate resin and the neat ethylene acid copolymer resin, and then feeding into the extruder hopper using a gravimetric feeder. The extrudate was cooled by passing through a water bath and subsequently pelletized using a strand cutter.

Ionomer Dispersant Blends 10 to 14 were prepared by melt blending an unneutralized ethylene acid copolymer (Acid copolymer 17) and a sodium ionomer (Ionomer 15) to form an ionomer with a weighted average level of neutralization. The blended samples were prepared on a 35 mm twin screw extruder with a feed rate of 50 lbs/h and a screw speed of 300 RPM. The barrel temperature was set to 200° C., and vacuum of 20 inHg was pulled through a vent port located after the mixing section. The unneutralized acid copolymer and sodium ionomer were separately fed into the extruder hopper using gravimetric feeders. The extrudate was cooled by passing through a water bath and subsequently pelletized using a strand cutter.

The aqueous polyolefin dispersion examples were prepared using a Berstorf (KraussMaffei) twin screw extruder having a 48 L/D and 25 mm screw diameter. The polyolefin resin (VERSIFY™ 3200) and partially neutralized ionomer dispersants of Table 1 were supplied to the feed throat of the extruder via a Schneck Mechatron loss-in-weight feeder and a K-Tron pellet feeder, respectively. The ionomer dispersants had been partially neutralized with sodium cation. The polyolefin resin and the partially neutralized ionomer dispersant were melt blended to form a polymer melt blend. The polymer melt blend was then emulsified in the presence of an initial aqueous stream and further neutralized with additional base (KOH) to form an emulsion phase. The initial aqueous feed, and additional base are supplied at the rates shown in Table 4 and are injected using ISCO syringe pumps (from Teledyne Isco, Inc., Lincoln NE, USA). The emulsion phase was then conveyed forward to a dilution and cooling zone of the extruder, where additional diluting water is added to the emulsion at the rates shown in Table 4 also by ISCO dual syringe pumps to form aqueous polyolefin dispersions having the solid level content shown in Table 5. The barrel temperature of the extruder was set to 150° C. and the extruder speed was 450 rpm. After the dispersion exited the extruder, it was allowed to cool to room temperature and then filtered via a 200 μm mesh size bag filter. The aqueous polyolefin dispersion examples had a final neutralization of 85 mol % of acid groups neutralized. Moreover, the aqueous polyolefin dispersion examples included 85 wt. % of polyolefin and 15 wt. % ionomer based on the total solids as listed in Table 5.

The ethylene acid copolymers were prepared by standard free-radical copolymerization methods, using high pressure, operating in a continuous manner. Monomers are fed into the reaction mixture in a proportion, which relates to the monomer's reactivity, and the amount desired to be incorporated. In this way, uniform, near-random distribution of monomer units along the chain is achieved. Polymerization in this manner is well known, and is described in U.S. Pat. No. 4,351,931 (Armitage), which is hereby incorporated by reference. Other polymerization techniques are described in U.S. Pat. No. 5,028,674 (Hatch et al.) and U.S. Pat. No. 5,057,593 (Statz), both of which are also hereby incorporated by reference. Additional aspects of the ionomer are provided below in Table 1. The ionomers of these acid copolymers were prepared as stated above.

VERSIFY™ 3200, which is produced by Dow Inc., Midland, MI, is a plastomer having a density of 0.876 g/cc and a melt flow rate of 8 g/10 min according to ASTM D1238 (230° C./2.16 kg).

PRIMACOR™ 5980i, which is produced by SK Chemicals, is an ethylene acrylic acid copolymer having a density of 0.958 g/cc and a melt index (I₂) of 300 g/10 min according to ASTM D1238 (@190° C./2.16 kg).

TABLE 3
Properties of Dispersants

| | | | Unneutralized | Mol % Acid | Melt Index |
|---|---|---|---|---|---|
| | | | Acid | Groups | after Initial |
| | | Dispersant % | Copolymer | Neutralized via | Sodium |
| | | Acid Type & | Melt Index | Initial Sodium | Neutralization |
| Examples | Dispersant | Content | (g/10 min) | Neutralization | (g/10 min) |
| Comparative | PRIMACOR | 20% AA | 300 | 0 | Not neutralized |
| Example 1 | 5980i | | | | |
| Inventive | Ionomer 2 | 19.3% MAA | 291 | 12.3 | 71.4 |
| Example 2 | | | | | |
| Inventive | Ionomer 3 | 20.5% MAA | 196 | 7.5 | 63.4 |
| Example 3 | | | | | |
| Comparative | Acid | 19.5% MAA | 102 | 0 | Not neutralized |
| Example 4 | copolymer 4 | | | | |
| Inventive | Ionomer 5 | 18.9% MAA | 303 | 12.9 | 63.1 |
| Example 5 | | | | | |
| Inventive | Ionomer 6 | 18.8% MAA | 293 | 12.5 | 73.2 |
| Example 6 | | | | | |
| Inventive | Ionomer 7 | 21.5% MAA | 576 | 18.9 | 77 |
| Example 7 | | | | | |
| Inventive | Ionomer 8 | 20.3% MAA | 285 | 11.7 | 68.3 |
| Example 8 | | | | | |
| Inventive | Ionomer 9 | 19.4% MAA | 890 | 25 | 90.8 |
| Example 9 | | | | | |
| Inventive | Ionomer | 19% MAA | Not applicable | 6.9 | 100 |
| Example 10 | Dispersant | | | | |
| | Blend 10 | | | | |
| | (86 wt % Acid | | | | |
| | Copolymer 17 + | | | | |
| | 14 wt % of | | | | |
| | ionomer 15) | | | | |
| Inventive | Ionomer | 19% MAA | Not applicable | 7.8 | 81 |
| Example 11 | Dispersant | | | | |
| | Blend 11 | | | | |
| | (84 wt % Acid | | | | |
| | Copolymer 17 + | | | | |
| | 16 wt % of | | | | |
| | ionomer 15) | | | | |
| Inventive | Ionomer | 19% MAA | Not applicable | 12.3 | 63 |
| Example 12 | Dispersant | | | | |
| | Blend 12 | | | | |
| | (75 wt % Acid | | | | |
| | Copolymer 17 + | | | | |
| | 25 wt % of | | | | |
| | ionomer 15) | | | | |
| Inventive | Ionomer | 19% MAA | Not applicable | 15.7 | 47 |
| Example 13 | Dispersant | | | | |
| | Blend 13 | | | | |
| | (68 wt % Acid | | | | |
| | Copolymer 17 + | | | | |
| | 32 wt % of | | | | |
| | ionomer 15)) | | | | |
| Comparative | Comparative | 19% MAA | Not applicable | 20.6 | 33 |
| Example 14 | Ionomer | | | | |
| | Dispersant | | | | |
| | Blend 14 | | | | |
| | (58 wt % Acid | | | | |
| | Copolymer 17 + | | | | |
| | 42 wt % of | | | | |
| | ionomer 15)) | | | | |
| Comparative | Ionomer 15 | 19% MAA | ~300 | 49 | 4.5 |
| Example 15 | | | | | |
| Comparative | Acid | 19.3% MAA | 291 | 0 | Not neutralized |
| Example 16 | Copolymer 16 | | | | |
| | (unneutralized | | | | |
| | Ionomer | | | | |
| | Dispersant 2) | | | | |
| Comparative | Acid | 19% MAA | ~250 | 0 | Not neutralized |
| Example 17 | Copolymer 17 | | | | |

TABLE 4
Processing Conditions

| | Polyole- | | Initial | Neutralizing | Dilution |
|---|---|---|---|---|---|
| | fin | Dispersant | Aqueous | Base (KOH) | Aqueous |
| | Feed | Feed | Feed | Feed | Feed |
| Examples | (g/min) | (g/min) | (ml/min) | (ml/min) | (ml/min) |
| Comparative | 64.3 | 11.3 | 12.22 | 4.01 | 80 |
| Example 1 | | | | | |
| Inventive | 64.3 | 11.3 | 13.14 | 2.861 | 100 |
| Example 2 | | | | | |
| Inventive | 64.3 | 11.3 | 15.67 | 2.56 | 100 |
| Example 3 | | | | | |
| Comparative | 64.3 | 11.3 | 17.06 | 3.382 | 100 |
| Example 4 | | | | | |
| Inventive | 64.3 | 11.3 | 17.62 | 3.012 | 100 |
| Example 5 | | | | | |
| Inventive | 64.3 | 11.3 | 18.97 | 2.99 | 100 |
| Example 6 | | | | | |
| Inventive | 64.3 | 11.3 | 9.64 | 3.14 | 100 |
| Example 7 | | | | | |
| Inventive | 64.3 | 11.3 | 11.24 | 2.534 | 100 |
| Example 8 | | | | | |
| Inventive | 64.3 | 11.3 | 13.88 | 1.969 | 100 |
| Example 9 | | | | | |
| Inventive | 64.3 | 11.3 | 15.47 | 2.84 | 70 |
| Example 10 | | | | | |
| Inventive | 64.3 | 11.3 | 15.5 | 2.8 | 70 |
| Example 11 | | | | | |
| Inventive | 64.3 | 11.3 | 16.73 | 2.66 | 70 |
| Example 12 | | | | | |
| Inventive | 64.3 | 11.3 | 15.64 | 2.54 | 70 |
| Example 13 | | | | | |
| Comparative | 64.3 | 11.3 | 14.67 | 2.38 | 70 |
| Example 14 | | | | | |

TABLE 5
Properties of Polyolefin Dispersion

| | | Processability | | Mean | |
|---|---|---|---|---|---|
| | | factor (breadth | | Particle | Dynamic |
| | Solids | of curve below | Phase | size | Viscosity |
| Examples | (wt. %) | 1.75 microns) | Separation | (μm) | (cP) |
| Comparative | 45.22% | 0 | No | 1.633 | — |
| Example 1 | | | | | |
| Inventive | 43.53% | 0.0763 | No | 0.807 | 74.6 |
| Example 2 | | | | | |
| Inventive | 43.53% | 0.0432 | No | 1.007 | 79 |
| Example 3 | | | | | |
| Comparative | 40.24% | 0.1131 | Yes | 1.309 | 47.6 |
| Example 4 | | | | | |
| Inventive | 43.89% | 0.0953 | No | 1.196 | 60.4 |
| Example 5 | | | | | |
| Inventive | 42.77% | 0.0784 | No | 1.201 | 48.6 |
| Example 6 | | | | | |
| Inventive | 43.71% | 0.1128 | No | 0.87 | 65.4 |
| Example 7 | | | | | |
| Inventive | 43.64% | 0.0589 | No | 1.063 | 72.2 |
| Example 8 | | | | | |
| Inventive | 44.02% | 0.086 | No | 0.921 | 60.8 |
| Example 9 | | | | | |
| Inventive | 51.13% | 0.0929 | No | 0.896 | 238.4 |
| Example 10 | | | | | |
| Inventive | 50.36% | 0.1208 | No | 1.258 | 187.2 |
| Example 11 | | | | | |
| Inventive | 50.76% | 0.0907 | No | 1.091 | 182.4 |
| Example 12 | | | | | |
| Inventive | 50.96% | 0.0634 | No | 0.922 | 181.6 |
| Example 13 | | | | | |
| Comparative | 50.77% | 0 | No | 0.984 | 138.4 |
| Example 14 | | | | | |
| Comparative | N/A - | N/A - | N/A - | N/A - | N/A - |
| Example 15 | Not | not | not | not | not |
| | process- | process- | process- | process- | process- |
| | able | able | able | able | able |
| Comparative | 49.75% | 0 | No | 1.607 | 95.2 |
| Example 16 | | | | | |
| Comparative | 43.25% | 0 | No | 1.036 | 41 |
| Example 17 | | | | | |

In Table 5, samples that formed dispersions with undesirable phase separation are denoted as “Yes” and those that did not are denoted as “No” in the phase separation column. Also, samples that formed robustly processable dispersions are denoted as having a processability factor >0. Those that were not processable are denoted by “Not processable”. A processability factor of 0 means that a dispersion was possible to form, but only at one tested condition of initial aqueous to polymer ratio, which is an indication that this dispersion would not be robust to different processing conditions.

As shown by the dispersion results in Table 5 above, Comparative Example 1, which was not partially neutralized prior to melt blending with the polyolefin, did not form an aqueous polyolefin dispersion with a high processability factor. A high processability factor, which is also indicative of a broad processability window, denotes a stable dispersion with a small particle size is formed using a wide range of initial aqueous/polymer ratios, as opposed to only being formed at one particular ratio. This is an indicator that the formulation is more resistant to small variations in the process. Comparative Examples 1, 4, 16, and 17 were not partially neutralized prior to melt blending the ionomer dispersant with the polyolefin and either gave a low processability factor or, in the case of comparative 4, phase separation. Comparative Example 4 was processable (as its processability factor was >0), but it showed phase separation. Comparative Examples 1, 16, and 17 did not have a high processability factor. Also seen in Tables 3 and 5, Comparative Example 14, which had a melt index of 33 g/10 min gave a low processability factor. Comparative Example 15, which contained 49% of acid groups initially neutralized, was not processable. All Inventive Examples contained acid groups neutralized in amounts ranging from about 0.01 mole % to 30 mole %. The Inventive Examples formed dispersions that were all processable, did not show phase separation, contained between 30 to 60 wt. % solids, contained fine particles with an average particle size <2 μm, and a processability factor above 0.04 indicating a high processability factor.

It will be apparent to persons of ordinary skill in the art that various modifications and variations can be made without departing from the scope disclosed herein. Since modifications, combinations, sub-combinations, and variations of the disclosed embodiments, which incorporate the spirit and substance disclosed herein, may occur to persons of ordinary skill in the art, the scope disclosed herein should be construed to include everything within the scope of the appended claims and their equivalents.

For the purposes of defining the present technology, the transitional phrase “consisting of” may be introduced in the claims as a closed preamble term limiting the scope of the claims to the recited components or steps and any naturally occurring impurities. For the purposes of defining the present technology, the transitional phrase “consisting essentially of” may be introduced in the claims to limit the scope of one or more claims to the recited elements, components, materials, or method steps as well as any non-recited elements, components, materials, or method steps that do not materially affect the novel characteristics of the claimed subject matter. The transitional phrases “consisting of” and “consisting essentially of” may be interpreted to be subsets of the open-ended transitional phrases, such as “comprising” and “including,” such that any use of an open ended phrase to introduce a recitation of a series of elements, components, materials, or steps should be interpreted to also disclose recitation of the series of elements, components, materials, or steps using the closed terms “consisting of” and “consisting essentially of.” For example, the recitation of a composition “comprising” components A, B, and C should be interpreted as also disclosing a composition “consisting of” components A, B, and C as well as a composition “consisting essentially of” components A, B, and C. Any quantitative value expressed in the present application may be considered to include open-ended embodiments consistent with the transitional phrases “comprising” or “including” as well as closed or partially closed embodiments consistent with the transitional phrases “consisting of” and “consisting essentially of.”

As used in the Specification and appended Claims, the singular forms “a”, “an”, and “the” include plural references unless the context clearly indicates otherwise. The verb “comprises” and its conjugated forms should be interpreted as referring to elements, components or steps in a non-exclusive manner. The referenced elements, components or steps may be present, utilized or combined with other elements, components or steps not expressly referenced.

It should be understood that any two quantitative values assigned to a property may constitute a range of that property, and all combinations of ranges formed from all stated quantitative values of a given property are contemplated in this disclosure. The subject matter disclosed herein has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter.

1. A method of producing an aqueous polyolefin dispersion comprising:
providing a partially neutralized ionomer dispersant, which comprises an ethylene acid copolymer wherein the ethylene acid copolymer comprises the polymerized reaction product of 70 to 85 wt. % ethylene and 15 to 30 wt. % carboxylic acid containing comonomer, based on the total weight of monomers present in the ethylene acid copolymer, wherein 0.01 to 30 mole % of total acid units of the ethylene acid copolymer are neutralized by alkali metal cations;
melt blending the partially neutralized ionomer dispersant and one or more polyolefins to produce a polymer melt blend;
emulsifying the polymer melt blend in the presence of water and additional base to produce an emulsion, wherein the additional base further neutralizes a fraction or all of the remaining acid units of the partially neutralized ionomer; and
diluting the emulsion with additional water to produce the aqueous polyolefin dispersion.

2. The method of claim 1, wherein the carboxylic acid containing comonomer comprises methacrylic acid, acrylic acid, or combinations thereof.

3. The method of claim 1, wherein melt blending and emulsifying occurs at a temperature from 100 to 250° C.

4. The method of claim 1, wherein the aqueous polyolefin dispersion comprises 30 to 60 wt. % total solids.

5. The method of claim 4, wherein the total solids have an average particle size of less than or equal to 2 μm.

6. The method of claim 1, wherein the alkali metal comprises sodium.

7. The method of claim 1, wherein the additional base comprises KOH.

8. The method of claim 1, wherein the melt index (I₂) of the partially neutralized ionomer dispersant is between 35 to 750 g/10 min, or between 60 and 250 g/10 min as determined according to ASTM D1238 (at 190° C. 2.16 kg).

9. The method of claim 1, wherein the melt index (I₂) of the ethylene acid copolymer prior to neutralization is between 100 and 1000 g/10 min, or between 200 to 400 g/10 min as determined according to ASTM D1238 (at 190° C., 2.16 kg).

10. The method of claim 1, wherein the partially neutralized ionomer dispersant has from 0.1 mole % to 30 mole %, from 1 mole % to 30 mole %, from 2 mole % to 30 mole %, from 2 to 20 mole %, or from 5 to 20 mole % of total acid units neutralized by alkali metal cations.

11. The method of claim 1, wherein the polyolefin comprises ethylene/alpha-olefin copolymer having a melt index (I₂) of 0.1 to 100.0 g/10 min as determined according to ASTM D1238 (at 190° C. 2.16 kg).

12. The method of claim 1, wherein the polyolefin comprises propylene/ethylene copolymer having a melt flow rate of 0.5 to 75 g/10 min as determined according to ASTM D-1238, Procedure B (condition 230° C./2.16 kg).

13. The method of any of claim 1, wherein the polyolefin is selected from the group consisting of polyethylene or polypropylene.

14. An aqueous polyolefin dispersion produced from the method of claim 1.

15. A coated article produced from the aqueous polyolefin dispersion of claim 14.
